(19) United States
(12) Patent Application Publication
(10) Pub. No.: US 2026/0161253 A1
(43) Pub. Date: Jun. 11, 2026

(54) TOUCH-SENSING SLIDER AND RELATED METHOD

(71) Applicant: UltraSense Systems, Inc., San Jose, CA (US)

(72) Inventors: Mo Li, Campbell, CA (US); Xiaoyue Jiang, San Jose, CA (US); Yonghuan David Ren, Milpitas, CA (US); Hao-Yen Tang, San Jose, CA (US)

(21) Appl. No.: 19/179,798

(22) Filed: Apr. 15, 2025

Related U.S. Application Data
(60) Provisional application No. 63/634,235, filed on Apr. 15, 2024.

(51) Int. Cl. G06F 3/044; G06F 3/0362; G06F 3/041

(52) U.S. Cl. CPC G06F 3/044; G06F 3/0362; G06F 3/0414; G06F 2203/04106

(57) ABSTRACT

A touch-sensing slider includes a cover stack, a touch sensor, and a signal processor. The cover stack has an outer surface that can be touched by a finger. The cover stack has a longitudinal direction along which the finger can touch and slide on the outer surface. The touch sensor includes piezoelectric capacitors mechanically coupled to the cover stack at its inner interface. The cover stack overlies the piezoelectric capacitors, and the piezoelectric capacitors include one or more piezoelectric members. The piezoelectric capacitors are configured as piezoelectric ultrasonic transducers (PUTs). The signal processor is coupled to the touch sensor and configured to receive signals from the PUTs while the touch sensor is active during a touch determination period. The touch determination period includes a plurality of sensing event time frames. Each of the sensing event time frames includes a plurality of sensing time windows. A related method is also disclosed.

### CROSS-REFERENCE TO RELATED APPLICATION(S)

This application claims the benefit of U.S. Provisional Patent Application No.:
63/634,235 filed on Apr. 15, 2024, entitled “TOUCH-SENSING SLIDER AND RELATED METHOD,” which is incorporated herein by reference in its entirety.

### BACKGROUND

Touch-sensing sliders are a common interface to allow a user to interact with electrical devices like computers, laptops, or other devices. Sliders are frequently found in applications where linear controls, such as volume controls, brightness controls, or control of other parameters having a range of values is beneficial. When used in these applications, touch sensitive sliders are popular because they have an intuitive operation to a user, provide high levels of accuracy enabling precise control and selection, and are responsive and provide instant feedback. Most commercial touch-sensing sliders are based on capacitive touch sensing, in which small changes in capacitance caused by the contact of a human figure with the slider are detected and used to determine the location of and pressure imparted by the finger. Although in widespread use, use of capacitive sensors are limited in certain respects. One shortcoming of capacitive touch sensitive sliders is that they operate best when incorporated on glass or other non-metallic substrates. That limits the materials in which capacitive touch-sensing sliders may be formed and prohibits incorporation in certain materials entirely. Another shortcoming of capacitive touch sensitive sliders is that their performance can degrade in certain environmental conditions, including the presence of water, dust, or extremes in temperature. It would therefore be beneficial to have a touch-sensing slider that relies on more than just the capacitive effect in order to broaden the applications and circumstances in which the touch-sensing slider may be used.

### BRIEF DESCRIPTION OF THE DRAWINGS

The disclosure may be more completely understood in consideration of the following detailed description of various embodiments of the disclosure in connection with the accompanying drawings, in which:

FIG. 1A is a schematic elevational view of an illustrative touch-sensing slider in which the touch sensor is adhered to the cover stack by an adhesive.

FIG. 1B is a schematic elevational view of an illustrative touch-sensing slider in which the touch sensor is encapsulated in a molded package and a portion of the molded package is configured as the cover stack.

FIG. 2 is a schematic plan view of an array of touch-sensing elements (e.g., piezoelectric ultrasonic transducers (PUTs)) extending along a longitudinal direction.

FIG. 3 is a schematic plan view of an array of touch-sensing elements (e.g., piezoelectric ultrasonic transducers (PUTs)) extending along a longitudinal direction and another direction.

FIG. 4A is a schematic elevational view of a touch-sensing slider according to some implementations. FIGS. 4B and 4C are schematic elevational views of respective implementations of PUTs that may be employed in the touch-sensing slider of FIG. 4A. In FIG. 4B, multiple PUTs share a common piezoelectric member. In FIG. 4C, there is a separate piezoelectric member for each of the PUTs. FIG. 4D is a schematic elevational view of an alternative implementation in which the PUTs are piezoelectric micromechanical ultrasonic transducers (PMUTs) in a silicon substrate.

FIGS. 5, 6, and 7 are schematic elevational views of touch-sensing sliders according to some implementations. In the example shown in FIG. 5, the signal processor is housed in a separate packaged IC (e.g., microcontroller unit (MCU)). In the example shown in FIG. 6, one portion of the signal processor is housed in the separate packaged IC (e.g., MCU) and other portions of the signal processor are housed in the respective touch sensor devices (e.g., touch sensor ICs). In the example shown in FIG. 7, portions of the signal processor are housed in the respective touch sensor devices (e.g., touch sensor ICs).

FIG. 8 is a schematic elevational view of a touch sensor according to some implementations, showing the arrangement of the electrodes of the PUTs and the electrical connections between these electrodes and input/output (I/O) electrodes (e.g., I/O pads).

FIG. 9A is a schematic elevational view of a touch sensor according to some other implementations, showing the arrangement of the electrodes of the PUTs and the electrical connections between these electrodes and input/output (I/O) electrodes (e.g., I/O pads). The arrangement of FIG. 9A differs from the arrangement of FIG. 8 in that the PUTs share a common electrode (in the example shown, a common upper electrode). FIG. 9B is a schematic plan view of the array of PUTs.

FIG. 10A is a schematic elevational view of a touch sensor according to some other implementations, showing the arrangement of the electrodes of the PUTs. The arrangement of FIG. 10A differs from the arrangements of FIG. 8 and FIG. 9A in that the PUT electrodes also function as I/O electrodes. FIG. 10B is a schematic elevational view of touch-sensing slider that incorporates the touch sensor of FIG. 10A.

FIG. 11A is a schematic timing diagram showing the relationships among the signal portions of the signals received by the signal processor from the PUTs during a sensing event time frame.

FIG. 11B is a schematic timing diagram showing the relationships among the sensing event time frames and the signal processing time frames during a touch determination period.

FIG. 12 is a schematic diagram of the response curves of three illustrative touch-sensing elements, illustrating a concept of determining a touch location.

FIG. 13 is a schematic view of an illustrative touch-sensing slider that additionally includes a wake-up sensor.

FIG. 14 is a schematic view of an illustrative touch-sensing slider in which the signal processor is configured to receive wake-up signals from an external source.

FIG. 15 is a flow diagram of a method of sensing touch in accordance with some embodiments.

FIG. 16 is a schematic plan view of an array of PUTs including transmitting-type PUTs and receiving-type PUTs.

FIG. 17A is a schematic view of waves transmitted by transmitting-type PUTs, in which the waves transmitted from one of the PUTs is independent of the waves transmitted by another of the PUTs. FIG. 17B is a schematic view of waves transmitted by transmitting-type PUTs, in which the waves interfere constructively to form a converging wavefront.

FIG. 18A is a schematic plan view of an array of PUTs. FIG. 18B is a table of transducer states for each of the PUTs of FIG. 18A at a plurality of sensing time windows.

FIG. 19 is a flow diagram of a process of making a monolithic IC (integrated circuit) incorporating a CMOS (complementary metal-oxide semiconductor) portion and a MEMS (micro-electro-mechanical systems) portion.

FIG. 20 is a flow diagram of a process of making a wafer-bonded IC incorporating a CMOS (complementary metal-oxide semiconductor) wafer portion and a MEMS (micro-electro-mechanical systems) wafer portion.

FIG. 21 is a flow diagram of a process of making a system in a package (SiP) incorporating a CMOS IC and a MEMS IC.

FIG. 22 is a flow diagram of a process of making a touch sensor device incorporating discrete (e.g., non-micromechanical) piezoelectric capacitors.

### DETAILED DESCRIPTION

The present disclosure relates to a touch-sensing slider which incorporates an array of piezoelectric capacitors configured as piezoelectric ultrasonic transducers (PUTs). A touch-sensing slider can be used in various applications to provide a user-friendly and intuitive interface. For example, a touch-sensing slider can be used in mobile devices (e.g., smartphones, tablet computers, laptop computers), household appliances (e.g., washing machines, dryers, light switches, kitchen appliances, remote control devices), medical devices, industrial appliances, office appliances, musical instruments, automobile interfaces, fitness equipment, home or office HVAC controls or automation, etc.

In one aspect, the touch-sensing slider includes a cover stack which has an outer surface that can be touched by a finger (e.g., during a touch event). The cover stack has a longitudinal direction along which the finger can touch and slide on the outer surface. The touch-sensing slider includes a touch sensor. The touch sensor includes PUTs mechanically coupled to the cover stack at its inner interface. The touch-sensing slider includes a signal processor coupled to the PUTs and configured to receive signals from the PUTs while the touch sensor is active during a touch determination period. Each of the PUTs is configured as a transmitting-type PUT and/or a receiving-type PUT.

In another aspect, the touch determination period includes a plurality of sensing event time frames. For each of the sensing event time frames, signals from the touch sensor are received by the signal processor. For each of the sensing event time frames, the transmitting-type PUTs transmit ultrasound waves towards the cover stack. For example, these ultrasound waves may undergo varying degrees of attenuation by absorption depending on whether there is an object (e.g., a finger) touching the outer surface. Ultrasound waves (e.g., reflected ultrasound waves) from the cover stack are received by the receiving-type PUTs. For each of the sensing event time frames, the signals received by the signal processor comprise signal portions in a time-division multiplexed arrangement, each of the signal portions being generated in accordance with the ultrasound waves received at one or more of the receiving-type PUTs.

In yet another aspect, signal processing time frames may be interleaved with sensing event time frames during the touch determination period. During the signal processing times frames, at least one of the piezoelectric capacitors may also be configured as a piezoelectric force-measuring element (PFE). In some implementations, at least one of the piezoelectric capacitors may be configured as a PUT (e.g., transmitting-type PUT and/or receiving-type PUT) during the sensing event time frames and may be configured as a PFE during the signal processing time frames.

Various features of the touch-sensing slider introduced above will now be described in further detail. The following description provides specific details for a thorough understanding and enabling description of these examples. One skilled in the relevant art will understand, however, that the technology discussed herein may be practiced without many of these details. Likewise, one skilled in the relevant art will also understand that the technology can include many other features not described in detail herein. Additionally, some well-known structures or functions may not be shown or described in detail below so as to avoid unnecessarily obscuring the relevant description.

The terminology used herein is to be interpreted in its broadest reasonable manner, even though it is being used in conjunction with a detailed description of some specific examples of the embodiments. Indeed, some terms may even be emphasized below; however, any terminology intended to be interpreted in any restricted manner will be overtly and specifically defined as such in this section.

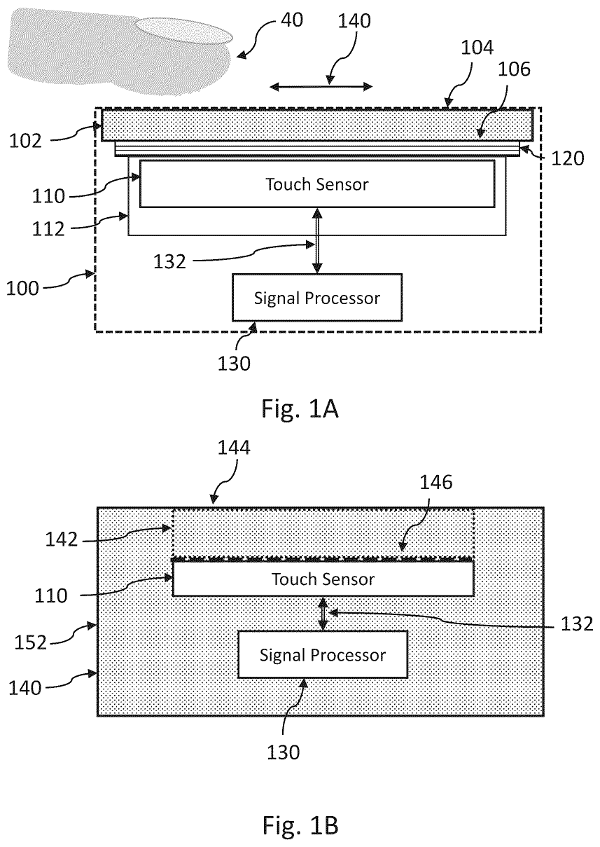

FIG. 1A is a schematic elevational view of an illustrative touch-sensing slider 100. The touch-sensing slider 100 includes a cover stack 102, a touch sensor 110, and a signal processor 130. The cover stack has an outer surface 104 which can be touched by a finger 40. Cover stack 102 can be made from any robust material layer(s) though which ultrasound waves can propagate. Materials suitable for use in a cover stack include metals (aluminum, aluminum alloy, steel) and electrically non-conductive materials such as wood, glass, plastic, leather, fabric, and ceramic. The cover stack may be a single layer of material or may comprise multiple layers of materials. The cover stack may comprise any suitable material singly or in combination. In the example shown, touch sensor 110 is encapsulated in a protective package 112. For example, touch sensor 110 can be a MEMS device or can comprise discrete elements (e.g., piezoelectric member(s), substrate(s), wiring, electrode(s)), and be encapsulated in a package 112. Signal processor 130 is connected via a bus (or other signal interconnection) 132 to touch sensor 110. Signal processor 130 is configured to receive signals from touch sensor 110 while touch sensor 110 is active during a touch determination period. Touch sensor 110 is mechanically coupled to cover stack 102 at its inner interface 106. In the example shown, touch sensor 110, in its packaged form, is adhered to cover stack 102 at the inner interface 106 by an adhesive. Some examples of suitable adhesives are: double-sided tape, pressure sensitive adhesive (PSA), epoxy adhesive, or acrylic adhesive. The cover stack 102 has a longitudinal direction 140 along which a finger can touch and slide on outer surface 104.

FIG. 1B is a schematic elevational view of another illustrative touch-sensing slider 144. The touch-sensing slider 144 includes a touch sensor 110, a signal processor 160, and a bus (or other signal interconnection) 132, as described with reference to FIG. 1A. In the example shown, touch sensor 110, signal processor 130, bus 132, and other components (not shown) are encapsulated in a molded package 152. Materials that are typically employed for forming the molded package are robust materials such as plastic, metal, and ceramic. In this implementation, a portion of the molded package 152 is configured as a cover stack 142: cover stack 142 has an outer surface 144 which can be touched by a finger, and an inner interface 146 at which touch sensor 110 is mechanically coupled. The cover stack portion 142 of molded package 152 is in the region between outer surface 144 and touch sensor 110; touch sensor 110 is configured to sense touch events that occur at the outer surface.

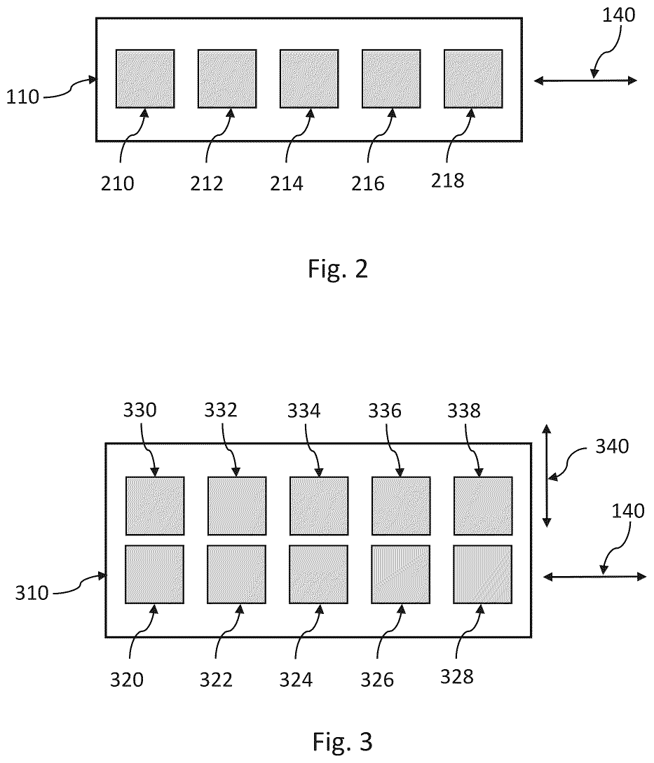

FIG. 2 is a schematic plan view of an illustrative touch sensor 110, which includes an array of touch-sensing elements (210, 212, 214, 216, 218) extending along a longitudinal direction 140. FIG. 3 is a schematic plan view of another illustrative touch sensor 310, which includes an array of touch-sensing elements. Touch-sensing elements 320, 322, 324, 326, and 328 are arrayed along longitudinal direction 140. Touch-sensing elements 330, 332, 334, 336, and 338 are arrayed along longitudinal direction 140. Touch-sensing elements 320 and 330 are arrayed along another direction 340, which in the example shown is approximately perpendicular to longitudinal direction 140. Similarly, touch-sensing elements 322 and 332 are arrayed along other direction 340, and so on. The touch-sensing elements may be piezoelectric capacitors configured as piezoelectric ultrasonic transducers (PUTs) (including piezoelectric micromechanical ultrasonic transducers (PMUTs)), as explained herein. Additionally, in some implementations, piezoelectric capacitors may be configured as piezoelectric force-measuring elements (PFEs) (including piezoelectric micromechanical force-measuring elements (PMFEs))

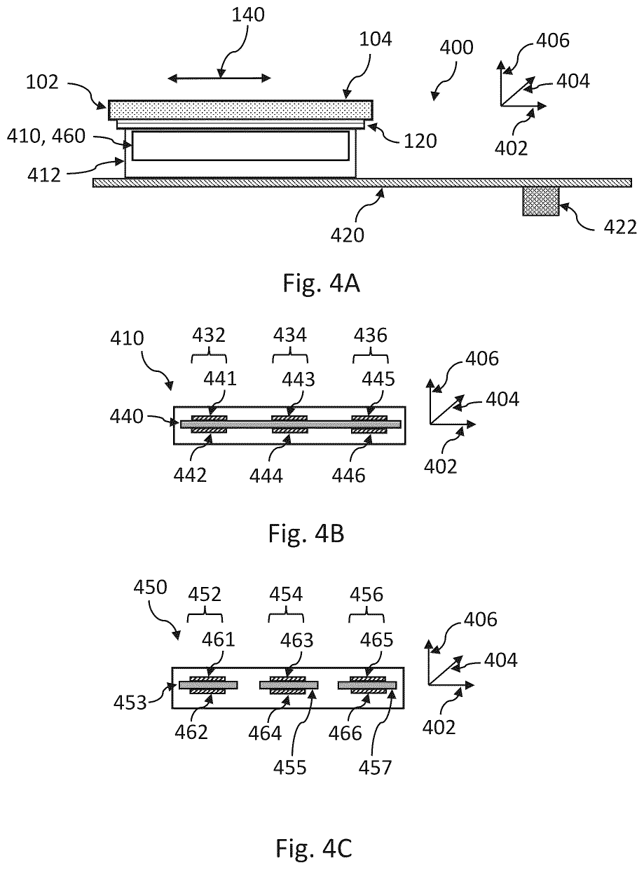

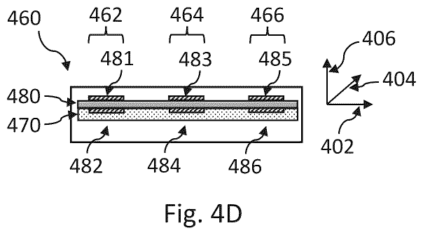

FIG. 4A is a schematic elevational view of a touch-sensing slider 400 according to some implementations. Touch-sensing slider 400 includes a cover stack 102 and a touch sensor (e.g., 410 or 450) encapsulated in a package 412 and adhered to cover stack 102 by an adhesive 120. An orthogonal coordinate system is shown: x-axis 402, y-axis 404, and z-axis 406. In the example shown, longitudinal direction 140 is approximately parallel to x-axis 402. Touch sensor 410 is described with reference to FIG. 4B and touch sensor 450 is described with reference to FIG. 4C. Touch-sensing slider 400 also includes a signal processor 422, which is shown as a separate IC (e.g., an application-specific integrated circuit (ASIC) comprising a signal processor such as an MCU). The touch sensor and the signal processor are mounted to a circuit board substrate 420 (e.g., a printed circuit board (PCB), flexible substrate). Not shown are electrical interconnections on or in the circuit board substrate between the touch sensor and signal processor 422. Also not shown are other components (e.g., other ICs, other transducers, power supplies, batteries) that may be connected to the circuit board substrate 420.

FIGS. 4B and 4C are schematic elevational views of respective touch sensors 410, 450 that may be employed in the touch-sensing slider of FIG. 4A. In some implementations, touch sensors 410, 450 may comprise discrete (e.g., non-micromechanical) piezoelectric capacitors. In such cases, the touch sensors may be larger than typical MEMS ICs. In FIG. 4B, touch sensor 410 includes piezoelectric capacitors 432, 434, 436 (configured as piezoelectric ultrasonic transducers (PUTs)) as the touch-sensing elements. For each piezoelectric capacitor, there is an upper electrode (441, 443, or 445), a lower electrode (442, 444, or 446), and a common capacitor dielectric (piezoelectric member) 440, shared by the three piezoelectric capacitors, between the upper electrodes and the lower electrodes. In the example shown, the capacitor dielectric 440 is a free-standing piezoelectric member (e.g., film). A free-standing piezoelectric member may be employed for discrete (e.g., non-micromechanical) piezoelectric capacitors. Suitable piezoelectric materials for a piezoelectric member include aluminum nitride, scandium-doped aluminum nitride, polyvinylidene fluoride (PVDF), lead zirconate titanate (PZT), KₓNa₁₋ₓNbO₃ (KNN), quartz, zinc oxide, lithium niobate, and Bi_{0.5}Na_{0.5}TiO₃ (BNT). An example of a suitable piezoelectric material for a free-standing piezoelectric member is PZT. In the example shown, the cross-talk among nearby PUTs is sufficiently low so that multiple PUTs can share a common piezoelectric member (e.g., piezoelectric layer 440) with no appreciable degradation in performance. In some cases, manufacturing costs may be reduced by adopting designs in which multiple PUTs share a common piezoelectric member.

In FIG. 4C, there is a separate piezoelectric member for each of the PUTs. In FIG. 4C, touch sensor 450 includes piezoelectric capacitors 452, 454, 456 (configured as PUTs) as the touch-sensing elements. For each piezoelectric capacitor, there is an upper electrode (461, 463, or 465), a lower electrode (462, 464, or 466), and a piezoelectric member (453, 455, or 457) between them. For example, the piezoelectric member (453, 455, or 457) may be formed by dicing a larger piezoelectric substrate into individual pieces.

Each of the PUTs may be configured to operate in a transmitting mode or a receiving mode. For example, consider PUT 452 (FIG. 4C). In a transmitting mode, upon application of a time-varying electric field between the electrodes (461, 462), the piezoelectric layer (piezoelectric member) 453 undergoes a contraction and expansion which results in mechanical motion (e.g., motion in the thickness direction, motion along a radial direction, shear motion, and/or flexural motion) of the piezoelectric member 453. As a result of the mechanical motion, ultrasound waves (of a predetermined frequency) are transmitted in a normal direction (z-axis 406) (i.e., in the z-direction normal to the x-y plane in which the piezoelectric layer extends). In a touch-sensing slider 400, at least a portion of the transmitted ultrasound waves reach outer surface 104 of cover stack 102, where the ultrasound waves may be attenuated by absorption by an object (e.g., a finger in contact with outer surface 104). At least a portion of the ultrasound waves are reflected back toward PUT 452. In a receiving mode, ultrasound waves (e.g., reflected ultrasound waves) of the predetermined frequency that are incident on the piezoelectric member 453 cause flexural motion of the piezoelectric member 453. As a result, time-varying voltage signals are generated between the electrodes (461, 462), which undergo signal conditioning (e.g., amplification, analog-to-digital conversion) before being received by a signal processor. The signal processor may determine, from the signals, whether a touch event has occurred, because of the greater attenuation of the ultrasound waves by the object touching the cover stack compared to when there is no touch. The signal processor may determine (1) a touch event has occurred when the received signal corresponds to an attenuation of the ultrasound waves greater than a predetermined threshold, and (2) a touch event has not occurred when the received signal corresponds to an attenuation of the ultrasound waves smaller than a predetermined threshold.

In some implementations, MEMS technologies may be employed to make MEMS ICs that incorporate piezoelectric capacitors. FIG. 4D is a schematic elevational view of an implementation in which the PUTs are piezoelectric micromechanical ultrasonic transducers (PMUTs) in a silicon substrate. In FIG. 4D, touch sensor (e.g., MEMS-type touch sensor) includes piezoelectric capacitors 462, 464, 466 (configured as PMUTs) as the touch-sensing elements. For each piezoelectric capacitor, there is an upper electrode (481, 483, or 485), a lower electrode (482, 484, or 486), and a piezoelectric layer (480) between them. In some implementations, aluminum nitride may be employed as a piezoelectric material in a PMUT. Aluminum nitride (AlN) may be preferred in some implementations because of its compatibility with CMOS processing technologies. In the example shown, the piezoelectric layer 480 has been deposited on a substrate 470 by a suitable process known in the art. The substrate 470 (and the piezoelectric layer 480) extend along the x-direction 402 and the y-direction 404. Substrate 470 may be a silicon substrate (e.g., silicon wafer on which the MEMS layers are deposited) or a previously deposited aluminum nitride layer which may also function as a mechanical layer. In the example shown, the lower electrodes (482, 484, 486) are formed on the substrate 470, and then the piezoelectric layer 480 is formed on the lower electrodes (482, 484, 486) and the substrate 470. Accordingly, the piezoelectric layer 480 is sandwiched by the lower and upper electrodes with no intervening substrate material.

In the foregoing description, piezoelectric capacitor 452 was described as being configured as a transmitting-type PUT and a receiving-type PUT. In addition, a piezoelectric capacitor (e.g., 452, 454, 456) may be configured as piezoelectric force-measuring elements (PFEs). For example, a piezoelectric capacitor may be configured as a transmitting-type PUT during a first time period, a receiving-type PUT during a second time period, and a PFE during a third time period. When a transient force is applied at cover stack 102 (e.g., by a finger touching or pressing cover stack 102 at outer surface 104), the transient force is transmitted to the neighboring PFEs (e.g., 452). The transient force causes a mechanical deformation of the PFE, which in turn causes a contraction (e.g., compressive stress) and/or expansion (e.g., tensile stress) of the piezoelectric member (e.g., 453). As a result, time-varying voltage signals are generated between the respective electrodes (e.g., 461 and 462) of a PFE. These time-varying voltage signals may undergo signal conditioning (e.g., amplification, analog-to-digital conversion, other signal conditioning processes) before being received by the signal processor. The signal processor may estimate (1) a transient strain (e.g., transient strain at the piezoelectric member) or (2) a transient applied force (e.g., transient force applied by a finger at the outer surface of the cover stack) from the time-varying voltage signals. The PFEs are sensitive to transient strain and may be distinguished from other elements that are sensitive to steady-state strain such as a strain gauge.

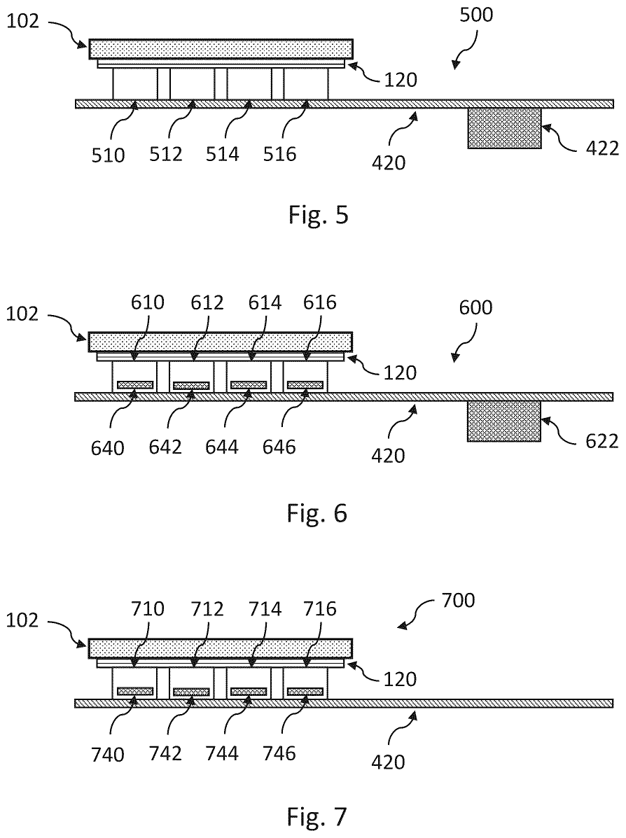

FIGS. 5, 6, and 7 are schematic elevational views of touch-sensing sliders according to some implementations, illustrating some variations in the arrangement of the signal processor. FIG. 5 shows a touch-sensing slider 500 comprising multiple touch sensor devices (510, 512, 514, 516), adhered to a cover stack 102 via an adhesive 120. The touch sensors are mounted to a circuit board substrate 420. The signal processor 422 is housed in a packaged IC (e.g., microcontroller unit (MCU)), separate from the touch sensor devices. In the example shown in FIG. 6, one portion of the signal processor (622) is housed in a separate packaged IC and other portions of the signal processor (640, 642, 644, 646) are housed in the respective touch sensor devices (610, 612, 614, 616). In the example shown in FIG. 7, there is no portion of the signal processor separate from the touch sensor devices. Instead, portions of the signal processor (740, 742, 744, 746) are housed in the respective touch sensor devices (710, 712, 714, 716). Each of the touch sensor devices shown in FIGS. 5, 6, and 7 (e.g., 510, 610, 710) may be implemented as a device comprising (1) a discrete PUT array, including, e.g., free-standing piezoelectric member and electrodes deposited or otherwise formed on the piezoelectric member, and (2) a signal processor implemented as an application-specific integrated circuit (ASIC), for example. In other instances, a touch sensor device may be implemented as a packaged IC (e.g., a touch sensor IC). A touch sensor IC may include a MEMS portion (including PMUT elements) and a CMOS portion incorporating signal processing capabilities (e.g., 640, 740). A touch sensor IC may incorporate varying levels of signal processing capability (e.g., touch sensor device 510 has a relatively low level of signal processing capability, touch sensor device 710 has a relatively high level of signal processing capability, and touch sensor device 610 has a signal processing capability intermediate between touch sensor devices 510 and 710).

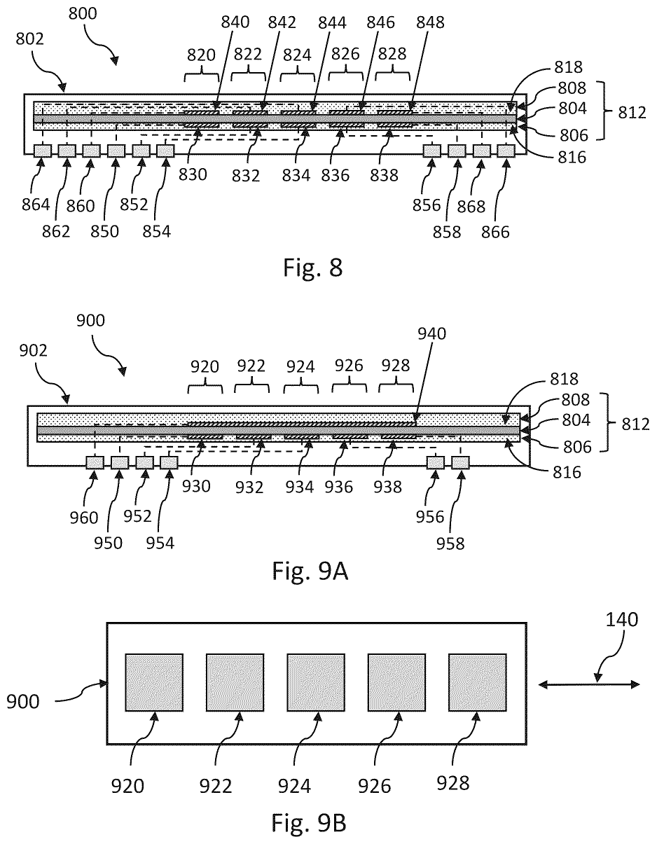

FIG. 8 is a schematic elevational view of a touch sensor 800 according to some implementations. Touch sensor 800 is encapsulated in a package 802. A piezoelectric member (e.g., layer or film) 804 extends across touch sensor 800. In the example shown, mechanical layers 806 and 808 are adjacent to and attached to the piezoelectric member at its lower surface 816 and upper surface 818, respectively. Piezoelectric member 804, lower mechanical layer 806, and upper mechanical layer 808 constitute a piezoelectric stack 812. Lower mechanical layer 806 and/or upper mechanical layer 808 are optional and may be employed to modify the mechanical or other properties of piezoelectric stack 812, as compared to piezoelectric member 804 by itself. In some implementations, a substrate (e.g., Si substrate) may function as a mechanical layer upon which the piezoelectric layer is deposited or otherwise formed. Touch sensor 800 includes PUTs 820, 822, 824, 826, and 828, which function as touch-sensing elements. Each PUT (piezoelectric capacitor) (820, 822, 824, 826, 828) includes a respective portion of the piezoelectric member 804, a respective lower electrode (830, 832, 834, 836, 838), and a respective upper electrode (840, 842, 844, 846, 848). The single piezoelectric member 804 is shared among these PUTs. In the example of touch sensor 800, input/output (I/O) connections are made at the bottom of the touch sensor. Ten I/O electrodes, serving the five PUTs, are shown: electrodes 850 and 860 connected to PUT 820, electrodes 852 and 862 connected to PUT 822, electrodes 854 and 864 connected to PUT 824, electrodes 856 and 866 connected to PUT 826, and electrodes 858 and 868 connected to PUT 828. Dotted lines show the interconnections between the I/O electrodes and the electrodes of the PUTs.

FIG. 9A is a schematic elevational view of a touch sensor 900 according to some other implementations. Touch sensor 900 is encapsulated in a package 902. Touch sensor 900 includes PUTs 920, 922, 924, 926, and 928, which function as touch-sensing elements. The arrangement of FIG. 9A differs from the arrangement of FIG. 8 in that the PUTs share a common electrode (in the example shown, a common upper electrode 940). Accordingly, there are six I/O electrodes serving the five PUTs: electrode 960 connected to common PUT electrode (upper electrode) 940, electrode 950 connected to bottom electrode 930 of PUT 920, electrode 952 connected to bottom electrode 932 of PUT 922, electrode 954 connected to bottom electrode 934 of PUT 924, electrode 956 connected to bottom electrode 936 of PUT 926, and electrode 958 connected to bottom electrode 938 of PUT 928. Dotted lines show the interconnections between the I/O electrodes and the electrodes of the PUTs. The implementation of FIG. 9A reduces the number of PUT electrodes, I/O electrodes, and PUT-to-I/O interconnections, compared to the implementation of FIG. 8. FIG. 9B is a schematic plan view of the array of PUTs as shown in elevational view in FIG. 9A. The PUT array extends along a longitudinal direction 140.

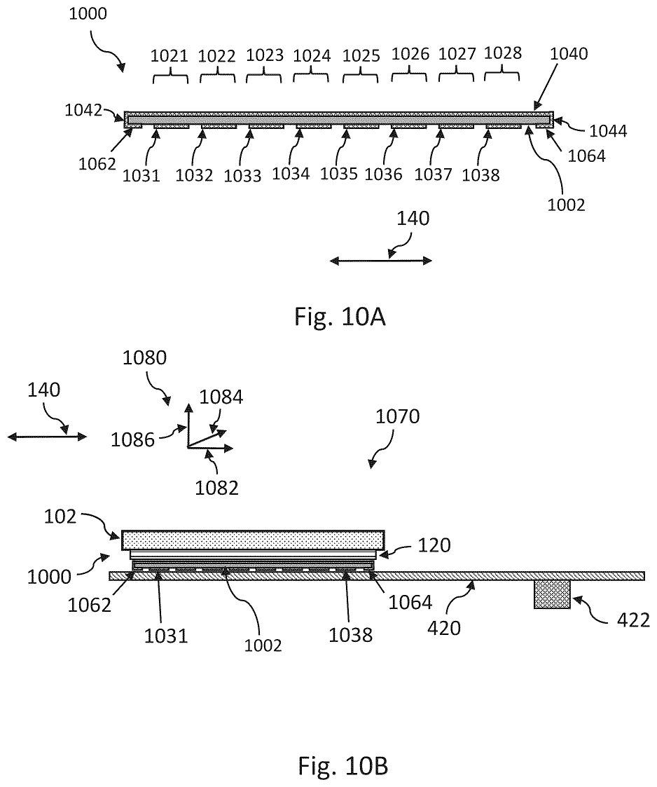

FIG. 10A is a schematic elevational view of a touch sensor 1000 according to some other implementations. Touch sensor 1000 includes a piezoelectric member 1002 in the form a free-standing film. In the example shown, mechanical layers have been omitted. In the example shown, touch sensor 1000 is not encapsulated in any package. A common upper PUT electrode 1040 is shared among the PUTs 1021, 1022, 1023, 1024, 1025, 1026, 1027, and 1028. Each of the PUTs includes a respective lower electrode (1031, 1032, 1033, 1034, 1035, 1036, 1037, and 1038). Upper electrode 1040 wraps around from the top to the bottom of the piezoelectric member 1002. Electrode portion 1042 wraps around piezoelectric member 1002 along its left edge to an electrode extension 1062 near the bottom left of piezoelectric member 1002. Similarly, electrode portion 1044 wraps around piezoelectric member 1002 along its right edge to an electrode extension 1064 near the bottom right of piezoelectric member 1002. Note that one of these electrode extensions (1062 or 1064) may be omitted. The arrangement of FIG. 10A differs from the arrangements of FIG. 8 and FIG. 9A in that the PUT electrodes also function as I/O electrodes. The PUT array extends along longitudinal direction 140.

FIG. 10B is a schematic elevational view of touch-sensing slider 1070 that incorporates touch sensor 1000 of FIG. 10A. In the example shown, touch sensor 1000 is mounted to a circuit board substrate 420. For example, all PUT electrodes (e.g., 1062, 1031, 1038, 1064, etc.) are bonded (e.g., bonded by soldering (solder-bonded), bonded by conductive adhesive) directly to respective electrodes on the circuit board substrate 420. Touch sensor 1000 is adhered to cover stack 102 via an adhesive 120 at the upper surface of touch sensor 1000. A signal processor 422 is also mounted to the circuit board substrate and is electrically coupled to the PUTs (e.g., configured to send signals to and receive signals from the PUTs). The PUT array extends along longitudinal direction 140. An orthogonal coordinate system 1080 includes an x-axis 1082 (shown as being approximately parallel to the longitudinal direction 140), a y-axis 1084 (directed into the page), and a z-axis 1086 (normal to the plane formed by the x-and y-axes). In the example shown, piezoelectric member 1002 extends along the x-and y-axes. Accordingly, z-axis 1086 is approximately normal to the plane of the piezoelectric member 1002.

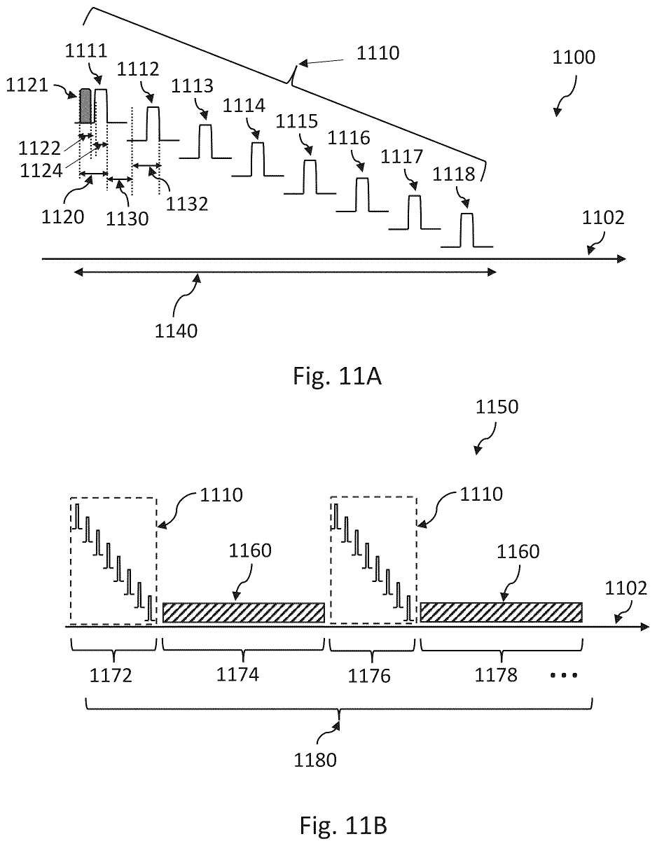

FIG. 11A is a schematic timing diagram 1100 showing the relationships among the signal portions of the signals received by the signal processor from the PUTs during a sensing event time frame 1140. FIG. 11B is a schematic timing diagram 1150 showing the relationships among the sensing event time frames 1172, 1176 and the signal processing time frames 1174, 1178 during a touch determination period 1180. Each of the sensing time frames 1172, 1176 (FIG. 11B) may correspond to sensing time frame 1140 (FIG. 11A). Timing diagrams 1100 and 1150 are shown with the x-axis 1102 indicating time. The signal timing is explained with reference to the eight PUTs shown at FIG. 10A and FIG. 10B. Timing diagram 1100 shows signals 1110 from the PUTs received at the signal processor 422. Signals 1110 comprise the following signal portions (ordered by time sequence): 1111 (signal portion from PUT 1021), 1112 (signal portion from PUT 1022), 1113 (signal portion from PUT 1023), 1114 (signal portion from PUT 1024), 1115 (signal portion from PUT 1025), 1116 (signal portion from PUT 1026), 1117 (signal portion from PUT 1027), and 1118 (signal portion from PUT 1028). Each of the signal portions occupies a respective portion of the sensing time frame 1140, and there is no overlap of the signal portions in time. Accordingly, these signal portions are in a time-division multiplexed arrangement.

Each of the signal portions (1111-1118) is generated in accordance with the ultrasound waves received at the respective PUTs (1021-1028) during a respective one of the sensing time windows (e.g., sensing time window 1120 is shown for signal portion 1111). Additional details are described for the example of PUT 1021. Sensing time window 1120 comprises a first time portion 1122 and a second time portion 1124 after the first time portion. During first time portion 1122, the transmitting-type PUT (e.g., PUT 1021 functioning as a transmitting-type PUT) transmits ultrasound waves towards the cover stack 102 in a predetermined frequency range (e.g., in a range of about 0.5 to about 20 MHz), with the ultrasound waves propagating along a normal direction (along z-axis 1086) approximately normal to a plane of the one or more piezoelectric members. For example, when a drive voltage signal (e.g., voltage in a range of about 1 to about 50 V, frequency in a range of about 0. 5 to about 20 MHz) is applied to the electrodes of a PUT, the PUT may transmit ultrasound waves of approximately the same frequency as the drive voltage along normal direction (along z-axis 1086). Such drive voltage signal may be generated by a suitable signal-generation circuit (e.g., circuitry in the signal processor 422 or other circuitry connected to (coupled to) PUT 1021). For illustration, the drive voltage signal applied to PUT 1021 during the first time portion 1122 is schematically shown as 1121 in FIG. 11A, although this drive voltage signal is not part of the signals 1110 received at the signal processor. The ultrasound waves undergo varying degrees of attenuation depending on objects (if any) in contact with the cover stack 102. A fraction of the ultrasound waves are reflected back towards the PUT(s) (e.g., PUT 1021).

During the second time portion 1124, the receiving-type PUT (e.g., PUT 1021 functioning as a receiving-type PUT) receives the ultrasound waves from the cover stack in the predetermined frequency range. The receiving-type PUT generates time-varying voltage signals in response to the received ultrasound signals. The signal processor (e.g., 422) receives a signal portion (e.g., 1111) that is generated in accordance with the ultrasound waves received at the receiving-type PUT (e.g., PUT 1021) during a respective sensing time window (e.g., 1120). In some implementations, the time-varying voltage signal generated at the receiving-type PUT may undergo amplification, analog-to-digital conversion (ADC), and/or other signal conditioning before it is received at the signal processor as a “signal portion”. In some implementations, a duration of each of the sensing time windows is about 0.1 μs or more, and/or about 1000 μs or less (e.g., in a range of about 0.1 μs to about 1000 μs). There is a second sensing time window 1132, associated with a second PUT 1022 and second signal portion 1112. In the example shown, there is a blank time window 1130 between adjacent sensing time windows 1120 and 1132.

FIG. 11B is a schematic timing diagram 1150 showing the relationships among the sensing event time frames 1172, 1176 and the signal processing time frames 1174, 1178 during a touch determination period 1180. Each of the sensing event time frames 1172, 1176 (FIG. 11B) may correspond to sensing event time frame 1140 (FIG. 11A). A touch determination period may include more than two sensing time event time frames. The touch sensor is active at least during the touch determination period (e.g., the touch sensor may also be active during other time periods). In some implementations, a duration of a touch determination period is about 100 ms or more, and/or about 3000 ms or less (e.g., in a range of about 100 ms to about 3000 ms). In some implementations, a duration of a sensing event time frame satisfies one or more of the following: about 100 μs or more, about 200 μs or more, about 10 ms or less, and about 2 ms or less. In some implementations, a duration of a sensing event time frame is in a range of about 100 μs to about 10 ms, about 100 μs to about 2 ms, about 200 μs to about 10 ms, or about 200 μs to about 2 ms. In the example shown, there are signal processing time frames interleaves with the sensing event time frames (e.g., signal processing time frame 1174 after sensing event time frame 1172 and before sensing event time frame 1178. In some implementations, a duration of a signal processing time frame may be in a range of about 1 μs to about 1 ms. The signal processor (e.g., 422) may carry out signal processing during the sensing event time frame and may carry out additional signal processing during the signal processing time frame. In some implementations, signals are received from the PUTs during the sensing event time frames whereas no signals are received from the PUTs during the signal processing time frames. However, other signals (e.g., signals from other sources, such as a wake-up sensor, an external signal source, or another sensor) may be received by the signal processor during the signal processing time frame. In some implementations, an example of another sensor is a piezoelectric force-measuring element (PFE). In some implementations, a piezoelectric capacitor that function as transmitting-type PUTs and/or receiving-type PUT during a sensing event time frame also functions as a PFE during a signal processing time frame.

During the sensing event time windows (e.g., 1172, 1176) (and additionally during the signal processing time frames 1174, 1178, in some implementations), the signal processor determines, from at least the signals (e.g., the signals from the PUTs during the sensing time windows, and optionally additional signals from the PFEs during the signal processing time windows), whether a touch event has occurred (e.g., a finger touch, finger press, finger slide, or another object contacting the cover stack), and at least one other characteristic of the touch event, if the signal processor has determined that the touch event has occurred. Herein, examples of “other characteristics” include touch velocity, touch direction, touch pattern, and touch location. In some cases, determining one of these other characteristics requires a determination of touch location(s). For example, determining a touch velocity may include (1) determining a first location and a first time at which a finger initially touches the outer surface 104 (of the cover stack 102) and starts to slide across the cover stack and (2) determining a second location and a second time (after the first time) at which the finger stops sliding and lifts away from the cover stack. For example, determining a touch pattern includes determining a series of touch locations at which a finger touches the cover stack. Other examples of “other characteristics” include transient applied force and transient strain. Characteristics such as transient strain and transient applied force may be determined in implementations in which the piezoelectric capacitor(s) function as PFE(s) during signal processing time frames. In such implementations, the other characteristics may be determined in accordance with the signals from the PUTs and the additional signals from the PFEs.

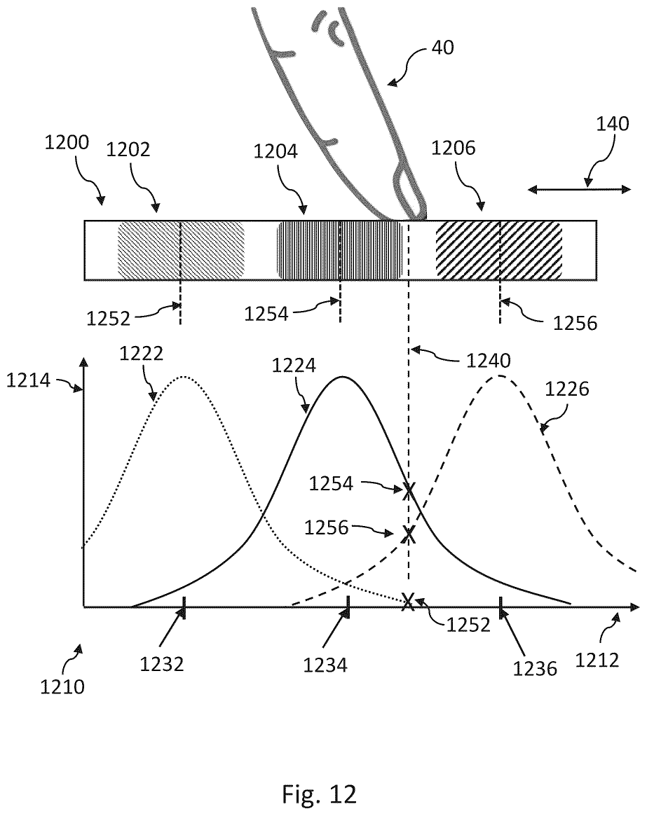

FIG. 12 is a schematic diagram of the response curves of three illustrative touch-sensing elements, illustrating a concept of determining a touch location. An illustrative touch sensor 1200 includes an array of PUTs (1202, 1204, 1206) extending along a longitudinal direction 140. In the example shown, a finger 40 is contacting the outer surface (of the cover stack) at a touch location 1240 (along the longitudinal direction 140). A graphical plot 1210 shows a respective response curve for each of the PUTs (response curve 1222 for PUT 1202, response curve 1224 for PUT 1204, response curve 1226 for PUT 1206). A response curve indicates a characteristic response (along y-axis 1214, in arbitrary units such as LSBs) of the PUT at each location along the x-axis 1212. Response curve 1222 exhibits a peak around x-axis position 1232, which is quite close to a central point 1252 of the PUT 1202 (along longitudinal axis 140). Response curve 1224 exhibits a peak around x-axis position 1234, which is quite close to a central point 1254 of the PUT 1204 (along longitudinal axis 140). Response curve 1226 exhibits a peak around x-axis position 1236, which is quite close to a central point 1256 of the PUT 1206 (along longitudinal axis 140). Accordingly, (1) each of the response curves has a peak at a central point and decreases with increasing distance away from the central point, and (2) two (or more) adjacent response curves are overlapped. In the example shown, the finger touch point 1240 is between PUT 1204 and PUT 1206. In some implementations, the response curves are indicative of signals at the signal processor, after amplification, analog-to-digital conversion (ADC), and other signal conditioning. Since the touch location 1240 is relatively far from the left PUT 1202, the response of the left PUT (at point 1252) is quite low, near a tail end of the response curve 1222. Since the touch location 1240 is closest to the middle PUT 1204, the response of the middle PUT (at point 1254) is quite high. Furthermore, the response of the right PUT (at point 1256) is between the responses of the left and middle PUTs. Since there is a response from two (or more, in the example shown three) PUTs, a touch location may be calculated or estimated from the comparing the response to the known response characteristics (e.g., response curves, peak response height, peak response location) of the PUTs.

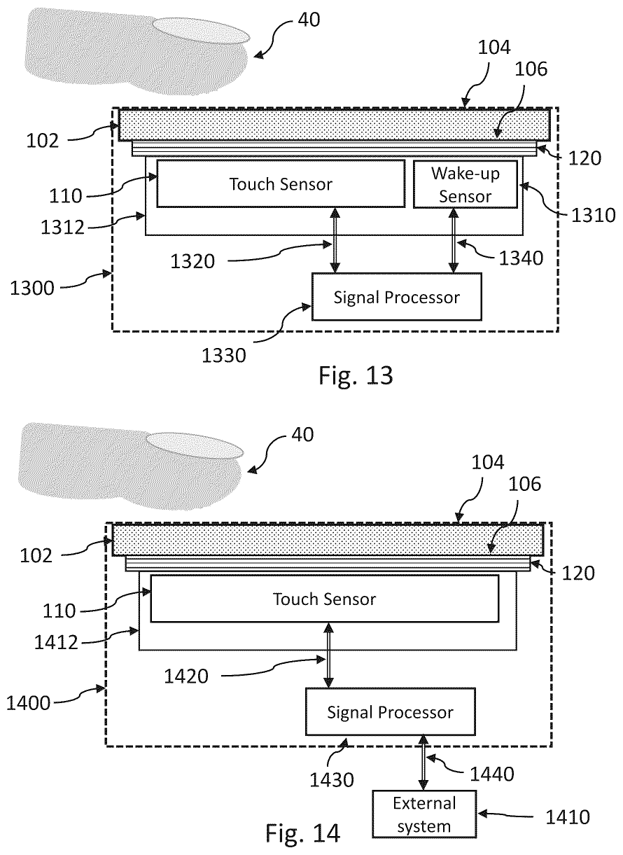

FIG. 13 is a schematic view of an illustrative touch-sensing slider 1300 that additionally includes a wake-up sensor 1310. Touch-sensing slider 1300 differs from touch-sensing slider 100 (FIG. 1A) in some respects. In the example shown, touch sensor 110 and wake-up sensor 1310 are encapsulated in a protective package 1312. Signal processor 1330 is connected via a bus (or other signal interconnection) 1320 to touch sensor 110 and is also connected via a bus (or other signal interconnection) 1340 to wake-up sensor 1310. In some implementations, the touch sensor and wake-up sensor may share a common bus connection to the signal processor. In some implementations, the wake-up sensor may be outside of any package that includes touch sensor. In some implementations, a piezoelectric force-measuring element (PFE) (including a piezoelectric micromechanical force-measuring element (PMFE)) may be employed as a wake-up sensor. In some implementations, a piezoresistive strain gauge or an accelerometer may be used as a wake-up sensor. Other sensors may be used as a wake-up sensor. The signal processor is configured to receive wake-up signals from the wake-up sensor.

FIG. 14 is a schematic view of an illustrative touch-sensing slider 1400 in which the signal processor is configured to receive wake-up signals from an external source 1410. Touch-sensing slider 1400 differs from touch-sensing slider 1300 (FIG. 13) in some respects. In the example shown, there is no wake-up sensor in the touch-sensing slider. Signal processor 1430 is connected via a bus (or other signal interconnection) 1420 to touch sensor 110 and is also connected via a bus (or other signal interconnection) 1440 to an external system 1410. While signal processor 1330 (FIG. 13) may also be connected to an external system (not shown), signal processor 1430 is configured to receive wake-up signals from external system 1410 (e.g., via bus connection 1440). Examples of an external system 1410 include an application processor and a microcontroller (MCU). In some implementations, the touch-sensing slider is configured to operate in one of multiple modes including a lower-power mode and a higher-power mode. The touch sensor is active in the higher-power mode and is inactive in the lower-power mode. It may be preferable to operate the touch-sensing in a lower-power mode most of the time and change to the higher-power mode only when necessary. A touch determination period (1180, FIG. 11B) is an example of a time period in which the touch-sensing slider is in the higher-power mode. The signal processor is configured to receive wake-up signals (e.g., from the wake-up sensor 1310 coupled to the signal processor or from an external source 1410). The signal processor is configured to determine whether to activate the touch sensor in accordance with the wake-up signals.

In some implementations, wake-up signals may be indicative of one or more of the following: (a) acceleration of an object, (b) vibration of an object, (c) force or pressure applied to an object, (d) a status of a user-interface device, and (e) a proximity of an object to the touch-sensing slider. Herein, “an object” may refer to a larger system of which the touch-sensing slider is a part. For example, the object may be a smartphone that incorporates the touch-sensing slider. Acceleration of, vibration of, or force or pressure applied any portion of the smartphone, that exceeds a predetermined threshold, may prompt a wake-up signal. Herein, a “status of a user-interface device” may refer to a status of a user-interface device of a larger system of which the touch-sensing slider is a part. For example, the user-interface device may be a touch screen of a larger system and its status may be that the touch screen is on. For example, the user-interface device may be an image sensing system of a smart doorbell (that incorporates the touch-sensing slider), and its status may be that there is a person approaching the smart doorbell as determined by the image sensing system. For example, the user-interface device may be a speaker of a larger system, and its status may be that the speaker is on (e.g., playing music, playing a telephone conversation). For example, the user-interface device may be a microphone of a larger system, and its status may be that the microphone is on (e.g., a person is speaking). Herein, “a proximity of an object to the touch-sensing slider” may applied in many suitable situations. For example, a touch-sensing slider may be employed in an automobile, as part of an access-control device or another user-interface device thereof. A matching RFID (radio frequency identification)-enabled automobile key approaching the automobile may be detected and may prompt a wake-up signal. For example, a touch-sensing slider may be employed in a device that is enabled for wireless communication (e.g., Bluetooth). A matching device approaching a system incorporating the touch-sensing slider may be detected and may prompt a wake-up signal.

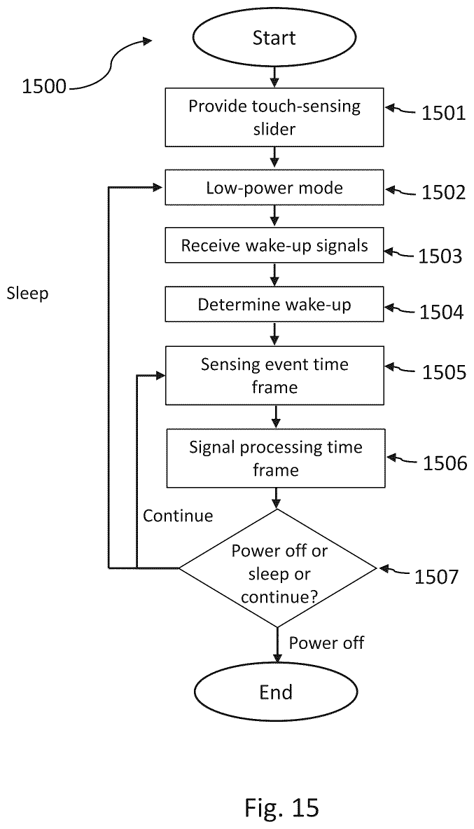

FIG. 15 is a flow diagram of a process of sensing touch in accordance with some embodiments. Process 1500 includes stages 1501-1507. At 1501, a touch-sensing slider, as described herein, is provided. Initially, the touch-sensing slider may be in a lower-power mode (stage 1502). It is not necessary that the touch-sensing slider configured to operate in a lower-power mode in addition to the higher-power mode. If the touch-sensing slider always operates in the higher-power mode, then stages 1502-1504 may be omitted and stages 1505-1507 may be carried out. At 1503, a wake-up signal may be received by the signal processor, as described with reference to FIG. 13 and FIG. 14. At 1504, the signal processor determines whether to activate the touch sensor in accordance with the wake-up signals. If the signal processor determines to activate the touch sensor, stages 1505-1507 are carried out. At 1505, the following actions are carried out during the sensing event time frame: (1) one or more of the transmitting-type PUTs transmit the ultrasound waves during each of the sensing time windows (e.g., see FIG. 11A, FIG. 11B, and related detailed description); (2) one or more of the receiving-type PUTs receive the ultrasound waves during each the sensing time windows (e.g., see FIG. 11A, FIG. 11B, and related detailed description); and (3) the signal processor receives the signals from the PUTs. The signals comprise signal portions in a time-division multiplexed arrangement, with each of the signal portions being generated in accordance with the ultrasound waves received at the one or more of the receiving-type PUTs during a respective one of the sensing time windows (e.g., see FIG. 11A, FIG. 11B, and related detailed description). Furthermore, at 1505, during the sensing event time frame, the signal processor determines, from at least the signals (e.g., the signals from the PUTs and any additional available signals), whether a touch event has occurred (see FIG. 4C and related detailed description). Yet furthermore, at 1505, during the sensing event time frame, the signal processor determines, from at least the signals (e.g., the signals from the PUTs and any additional available signals), at least one other characteristic of the touch event, if the signal processor has determined that the touch event has occurred (see FIG. 11A, FIG. 11B, FIG. 12, and related detailed description). Stage 1506 relates to any actions that are carried out during an optional signal processing time frame. Signal processing time frames are interleaved with sensing event time frames. At 1506, additional signal processing may be carried out, to determine, for example, (1) whether a touch event has occurred, and/or (2) at least one other characteristic of the touch event, if the signal processor has determined that the touch event has occurred. During the signal processing time frames, additional signals (i.e., other than the signals received from the PUTs during the sensing event time frames) may be available. An example of such additional signals is signals from PFEs during the signal processing time frames. Additional signal processing on such a combination of PUT and PFE signals may improve false positive rejection (e.g., better exclude events at the outer surface that are not touch events) and may also enable determination of other characteristics of the touch event such as the transient applied force or transient strain.

In some implementations, stages 1505-1506 may be repeated for all of the sensing event time frames of a touch determination period, although this repetition is not specifically indicated in FIG. 15. At 1507, three or more options are possible. A first option is that the touch-sensing slider powers off. For example, this may occur if the power supply is turned off or a battery power source is depleted. A second option is that the touch-sensing slider goes into a lower-power mode (e.g., the touch sensor is inactive in the lower-power mode) upon completion of a touch determination period. Otherwise, a third option is that stages 1505-1507 are repeated for additional time beyond the touch determination period. In some implementations, a touch determination period may be in a range of 1 ms to 3000 ms, in a range of 1 ms to 100 ms, in a range of 100 ms to 1000 ms, or in a range of 1000 ms to 3000 ms.

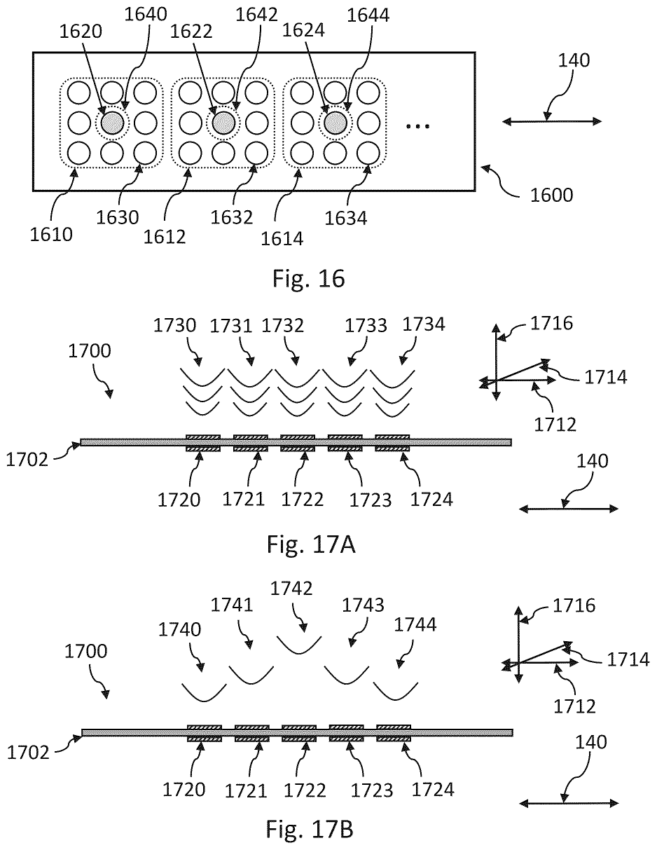

FIG. 16 is a schematic plan view of an array 1600 of PUTs including transmitting-type PUTs and receiving-type PUTs. The array 1600 extends along a longitudinal direction 140. In the example shown, there are three touch-sensing elements (1610, 1612, 1614). Touch-sensing element (1610, 1612, 1614) includes transmitting-type PUTs (1630, 1632, 1634) (indicated as white circles, there are 8 transmitting-type PUTs for each touch-sensing element) and a receiving-type PUT (1620, 1622, 1624) (grey circles). In the example shown, each of the PUTs is either a transmitting-type PUT, or a receiving-type PUT but not both. In the example shown, the transmitting-type PUTs surround a receiving-type PUT in the middle. Furthermore, the PUTs are shown as being approximately circular or approximately round whereas other examples PUTs (e.g., FIG. 2, FIG. 3, FIG. 9B) are shown as being approximately rectangular or approximately square. One advantage of the arrangement of FIG. 16 in which there are more transmitting-type PUTs than receiving-type PUTs (e.g., in the example shown, a ratio of transmitting-type PUTs to receiving-type PUTs is 8:1, with the PUTs being about the same in area) is that the power of the transmitting ultrasound waves may be increased. In some implementations, the power enhancement may be attained when the ultrasound waves transmitted by the transmitting-type PUTs interfere constructively.

FIG. 17A is a schematic elevational view of a touch sensor 1700 comprising a piezoelectric member 1702 and PUTs 1720-1724 at respective locations along the piezoelectric member 1702. The PUTs are arrayed along the longitudinal direction 140. The plane of the piezoelectric member is approximately parallel to the plane formed by the x-axis 1712 and the y-axis 1714. FIG. 17A schematically shows respective example waveforms (1730-1734) transmitted by each of the PUTs (1720-1724). These transmitted waveforms propagate along the normal direction (direction of the z-axis 1716, direction approximately normal to the plane of the piezoelectric member). In the example shown (FIG. 17A), the ultrasound waves transmitted from each of the PUTs is independent of the ultrasound waves transmitted by other ones of the PUTs. Accordingly, there is no constructive interference in the example of FIG. 17A. The ultrasound waves expand laterally as they travel further away from the transmitting PUT. FIG. 17B shows the same touch sensor 1700 as in FIG. 17A. FIG. 17B schematically shows respective example waveforms (1740-1744) transmitted by each of the PUTs (1720-1724). In the example shown (FIG. 17B), the waveform 1742 at the center (transmitted by central PUT 1722) is followed, with a predetermined phase delay, by waveforms 1741, 1743 outside of the center (transmitted by PUTs 1721, 1723), which in turn are followed, with a predetermined phase delay, by waveforms 1740, 1744 further outside of center (transmitted by PUTs 1720, 1724). These ultrasound waves interfere constructively and form a beam that converges near a point above the central PUT 1722 (e.g., a point above the central PUT 1722 at the outside surface of the cover stack, when the cover stack and the touch sensor are assembled together and mechanically coupled to each other). This is an example of beam-forming, in which ultrasound waves transmitted from multiple PUTs are constructively interfered to form a unified wavefront. Accordingly, in this manner, waveforms with relatively narrow beamwidths may be obtained. In some implementations, the ultrasound waves transmitted by the transmitting-type PUTs have a beamwidth in a range of 100 μm to 10 mm at the outer surface of the cover stack. In some implementations, the lateral dimensions of the PUTs (piezoelectric capacitors) are in a range of about 100 μm to about 10 mm, and the beamwidths are comparable to these lateral dimensions.

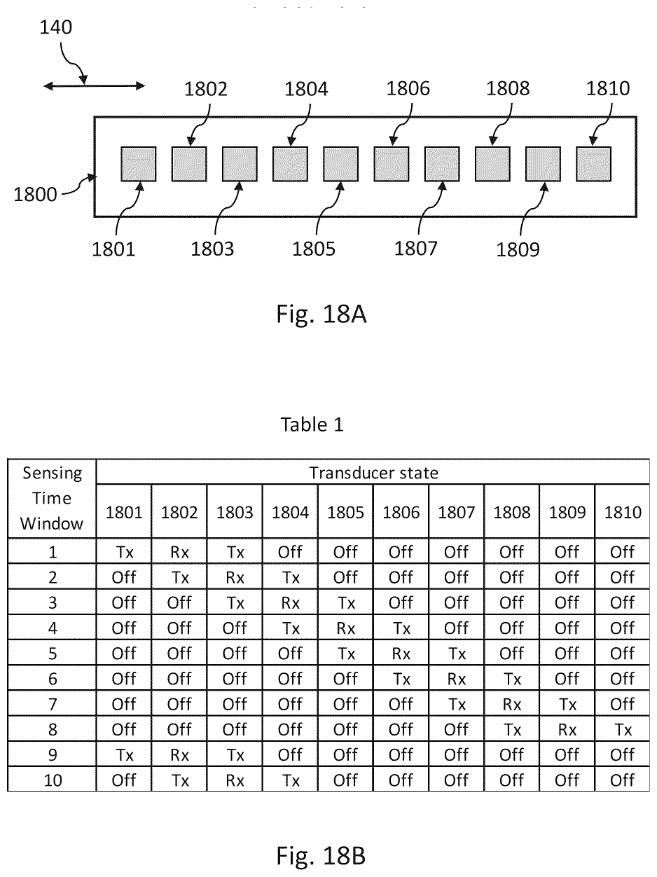

FIG. 18A is a schematic plan view of an array 1800 of PUTs (1801-1810), extending along the longitudinal direction 140. FIG. 18B shows a Table 1, showing the transducer states for each of the PUTs of FIG. 18A at each sensing time window. Herein, Tx indicates that the PUT is in transmission mode (is a transmission-type PUT) during that sensing time window, Rx indicates that the PUT is in receiving mode (is a receiving-type PUT) during that sensing time window, and “Off” indicates that the PUT is neither transmitting nor receiving during that sensing time window. For example, a PUT may be connected to a transmit/receive (T/R) switch. When the PUT is in transmit mode, it may be connected to a driver circuit via the T/R switch, and when the PUT is in the receive mode, it may be connected to a receive circuit via the T/R switch. For illustration, ten sensing time windows are shown in Table 1. For example, during sensing time window #1, PUT 1801 is transmitting, PUT 1802 is receiving, PUT 1803 is transmitting, and PUTs 1804-1810 are in “Off” state. Accordingly, during sensing time window #1, PUTs 1801-1803 constitute the touch-sensing element. It may be preferable to synchronize the operation of the transmitting PUTs 1801 and 1803 so that their ultrasound waves interfere constructively. In some implementations, a greater ultrasound power output and a better signal-to-noise performance may be obtained by using multiple PUTs for transmission than by using a single PUT for transmission. During sensing time window #2, PUT 1802 is transmitting, PUT 1803 is receiving, PUT 1804 is transmitting, and PUTs 1801 and 1805-1810 are in “Off” state. Accordingly, during sensing time window #1, PUTs 1802-1804 constitute the touch-sensing element. The touch-sensing element moves (e.g., shifts rightward along longitudinal direction 140) for each subsequent sensing time window. Eventually, at sensing time window #9, the touch-sensing element is at the same location as was at sensing time window #1. In the example shown, the PUTs that have only one neighboring PUT (i.e., leftmost PUT 1801 and rightmost PUT 1810) have transmitting and “Off” modes while the PUTs that have two neighboring PUTs (i.e., the interior PUTs 1802-1809) have transmitting, receiving, and “Off” modes. Accordingly, by employing each PUT to function in multiple modes (e.g., transmitting, as well as receiving, for some PUTs), the total number of PUTs required to implement a certain number of touch-sensing elements is reduced, compared to arrangements in which each PUT is dedicated as a transmitting-type PUT or a receiving-type PUT. In other implementations, the leftmost PUT 1801 and rightmost PUT 1810 may additionally have a receiving mode. In yet other implementations, at least one (e.g., one, two, three, all) of the piezoelectric capacitors (1801-1810) may also be configured as PFE(s) (e.g., during signal processing time frames).

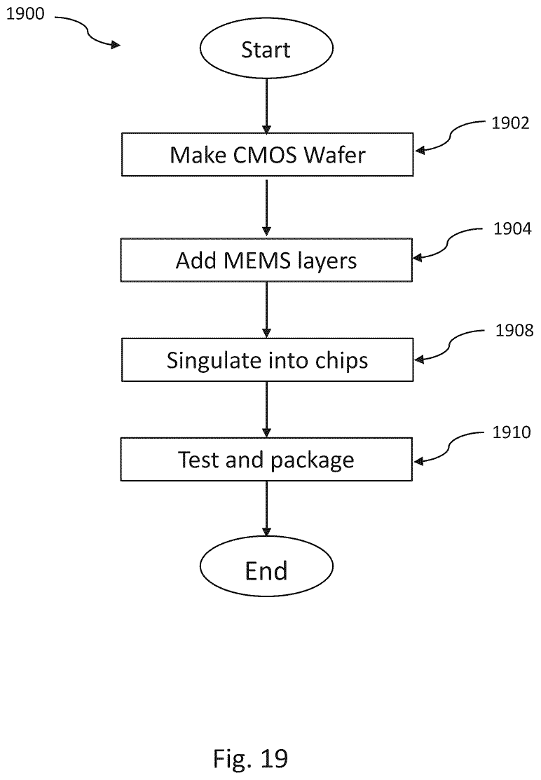

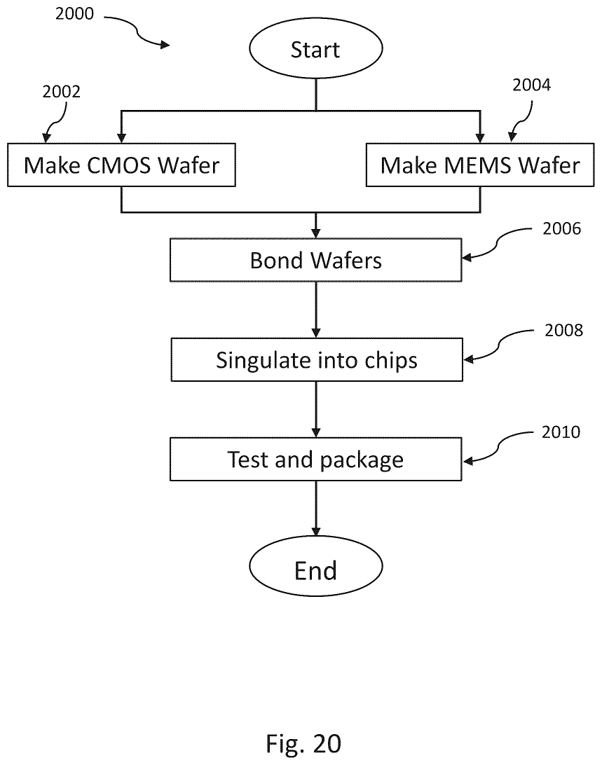

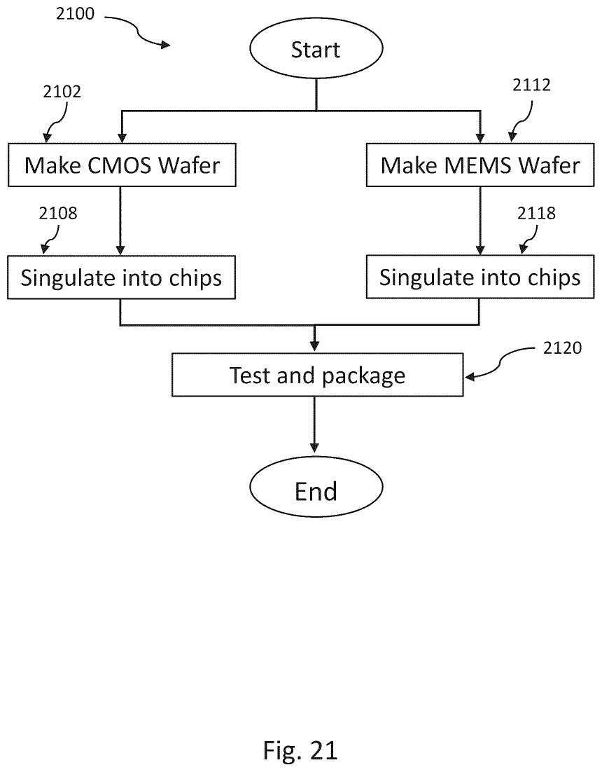

FIG. 19, FIG. 20, and FIG. 21 are used to illustrate variations in manufacturing processes and structures of touch sensor ICs. FIG. 19 is a flow diagram of a process 1900 of making a monolithic IC (integrated circuit) incorporating a CMOS (complementary metal-oxide semiconductor) portion and a MEMS (micro-electro-mechanical systems) portion. Process 1900 may be employed to make a touch sensor IC that includes a MEMS portion (including PMUTs) and a CMOS portion incorporating a signal processor. Herein, the term “monolithic IC” is used to refer to an IC device that has been singulated from a single wafer (e.g., silicon wafer). In the examples illustrated in FIG. 6 and FIG. 7, the touch sensor devices (e.g., 610, 710) may be touch sensor ICs. Process 1900 includes stages 1902, 1904, 1908, and 1910. At stage 1902, CMOS processing is carried out on a substrate (e.g., silicon wafer) to form CMOS circuitry (e.g., signal processor). At stage 1904, MEMS processing is carried on the same substrate to form MEMS devices (e.g., PMUTs, PMFEs). Upon completion of stage 1904, the substrate includes a CMOS portion on top of the substrate and a MEMS portion on top of the CMOS portion. At stage 1908, the substrate is singulated into chips. At stage 1910, the chips undergo back-end processing including testing and packaging.

FIG. 20 is a flow diagram of a process 2000 of making a wafer-bonded IC incorporating a CMOS (complementary metal-oxide semiconductor) wafer portion and a MEMS (micro-electro-mechanical systems) wafer portion. Process 2000 may be employed to make a touch sensor IC that includes a MEMS portion (including PMUTs) and a CMOS portion incorporating a signal processor. Process 2000 includes stages 2002, 2004, 2006, 2008, and 2010. At stage 2002, CMOS processing is carried out on a first substrate (e.g., silicon wafer) to form CMOS circuitry (e.g., signal processor). At stage 2004, MEMS processing is carried on a second substrate (e.g., silicon wafer, as well as other options such as glass substrate, quartz substrate, etc.) to form MEMS devices (e.g., PMUTs, PMFEs). At stage 2006, the first substrate and second substrate are adhered to each other, by a wafer-bonding process. At stage 2008, the wafer-bonded substrate assembly is singulated into chips. At stage 2010, the chips undergo back-end processing including testing and packaging.

FIG. 21 is a flow diagram of a process 2100 of making a system in a package (SiP) incorporating a CMOS IC and a MEMS IC. Process 2100 includes stages 2102, 2108, 2112, 2118, and 2120. At stage 2102, CMOS processing is carried out on a first substrate (e.g., silicon wafer) to form CMOS circuitry (e.g., signal processor). At stage 2108, the first substrate after CMOS processing is singulated into CMOS chips. At stage 2112, MEMS processing is carried on a second substrate (e.g., silicon wafer, as well as other options such as glass substrate, quartz substrate, etc.) to form MEMS devices (e.g., PMUTs, PMFEs). At stage 2118, the second substrate after MEMS processing is singulated into MEMS chips. At stage 2120, the CMOS chips and the MEMS chips undergo undergo back-end processing including testing and packaging into SiPs.

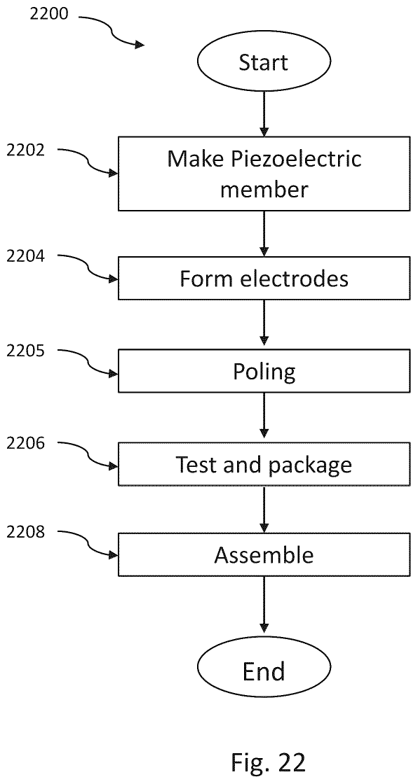

FIG. 22 is a flow diagram of a process 2200 of making a touch sensor device incorporating discrete (e.g., non-micromechanical) piezoelectric capacitors. Process 2200 includes stages 2202, 2204, 2205, 2206, and 2208. At stage 2202, a piezoelectric member is made or provided, to the desired dimensions. As described with reference to FIG. 4B and FIG. 4C, a piezoelectric member may be shared among multiple piezoelectric capacitors, or a respective piezoelectric member may be made or provided for each piezoelectric capacitor. At stage 2204, electrodes are formed on the piezoelectric member(s) to obtain the piezoelectric capacitors. At stage 2205, a poling operation may be carried out: a voltage is applied to the piezoelectric member between the electrodes (e.g., the electrodes formed at stage 2204) to form a built-in piezoelectric polarization. At stage 2206, the piezoelectric capacitors may undergo any necessary testing and packaging. As described with reference to FIG. 10A and FIG. 10B, the necessary packaging may be minimal in some implementations. At stage 2208, the piezoelectric capacitors may undergo final assembly into a larger system, such as mounting (e.g., solder bonding to a circuit board substrate).

Additional information about piezoelectric micromechanical force-measuring elements (PMFEs) and piezoelectric micromechanical ultrasonic transducers (PMUTs) can be found in U.S. Patent Application Publication Nos. US 2021/0181041 A1 and US 2021/0242393 A1. Additional information about discrete piezoelectric capacitors generally may be found in U.S. Patent Application Publication No. 2021/0242393 A1.

In this disclosure, the words “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the invention. The recitations of numerical ranges by endpoints include all numbers subsumed within that range (e.g., 1 to 5 includes 1, 1.5, 2, 2.75, 3, 3.80, 4, 5, etc.). 1For any method disclosed herein that includes discrete steps, the steps may be conducted in any feasible order. As appropriate, any combination of two or more steps may be conducted simultaneously.

### Examples

In some aspects, the techniques described herein relate to a touch-sensing slider, including: a cover stack having an outer surface that can be touched by a finger, the cover stack having a longitudinal direction along which the finger can touch and slide on the outer surface; a touch sensor including piezoelectric capacitors mechanically coupled to the cover stack at its inner interface, the cover stack overlying the piezoelectric capacitors, the piezoelectric capacitors including one or more piezoelectric members, the piezoelectric capacitors being configured as piezoelectric ultrasonic transducers (PUTs); and a signal processor coupled to the touch sensor and configured to receive signals from the PUTs while the touch sensor is active during a touch determination period, wherein: each of the PUTs is configured as a transmitting-type PUT and/or a receiving-type PUT; the piezoelectric capacitors are arranged in an array extending along at least

one direction including the longitudinal direction; the transmitting-type PUTs are configured to transmit ultrasound waves towards the cover stack in a predetermined frequency range, the ultrasound waves propagating along a normal direction approximately normal to a plane of the one or more piezoelectric members; the receiving-type PUTs are configured to receive the ultrasound waves from the cover stack in the predetermined frequency range; the touch determination period includes a plurality of sensing event time frames; a duration of each of the sensing event time frames is 10 ms or less; each of the sensing event time frames includes a plurality of sensing time windows; for each of the sensing event time frames, the signals include signal portions in a time-division multiplexed arrangement, each of the signal portions being generated in accordance with the ultrasound waves received at one or more of the receiving-type PUTs during a respective one of the sensing time windows, one or more of the transmitting-type PUTs transmitting the ultrasound waves during the respective one of the sensing time windows; the signal processor is configured to determine, from at least the signals, whether a touch event has occurred; and the signal processor is configured to determine, from at least the signals, at least one other characteristic of the touch event, if the signal processor has determined that the touch event has occurred.

In some aspects, the techniques described herein relate to a touch-sensing slider, wherein the at least one other characteristic is selected from touch velocity, touch direction, touch pattern, touch location, transient strain, and transient applied force.

In some aspects, the techniques described herein relate to a touch-sensing slider, wherein at least two of the piezoelectric capacitors share a common piezoelectric member among the one or more piezoelectric members.

In some aspects, the techniques described herein relate to a touch-sensing slider, wherein at least two of the piezoelectric capacitors share a common electrode.

In some aspects, the techniques described herein relate to a touch-sensing slider, wherein: the PUTs are piezoelectric micromechanical ultrasonic transducers (PMUTs); and the PMUTs are part of a monolithic IC.

In some aspects, the techniques described herein relate to a touch-sensing slider, wherein the monolithic IC includes the signal processor.

In some aspects, the techniques described herein relate to a touch-sensing slider, wherein the touch sensor is adhered to the cover stack at the inner interface by an adhesive including double-sided tape, pressure sensitive adhesive (PSA), epoxy adhesive, or acrylic adhesive.

In some aspects, the techniques described herein relate to a touch-sensing slider, wherein: at least the touch sensor is encapsulated in a molded package; and at least a portion of the molded package is configured as the cover stack.

In some aspects, the techniques described herein relate to a touch-sensing slider, wherein the piezoelectric member includes aluminum nitride, scandium-doped aluminum nitride, polyvinylidene fluoride (PVDF), lead zirconate titanate (PZT), KxNa1-xNbO3 (KNN), quartz, zinc oxide, lithium niobate, or Bi0.5Na0.5TiO3 (BNT).

In some aspects, the techniques described herein relate to a touch-sensing slider, wherein at least one of the piezoelectric capacitors is also configured as a piezoelectric force-measuring element (PFE).

In some aspects, the techniques described herein relate to a touch-sensing slider, wherein: the touch determination period additionally includes a plurality of signal processing time frames, the signal processing time frames being interleaved with the sensing event time frames; and the signal processor receives additional signals from the touch sensor during the signal processing time frames; and the additional signals include signals from the PFE.

In some aspects, the techniques described herein relate to a touch-sensing slider, wherein the ultrasound waves transmitted by the transmitting-type PUTs have a beamwidth in a range of 100 μm to 10 mm at the outer surface of the cover stack.

In some aspects, the techniques described herein relate to a touch-sensing slider, wherein the touch-sensing slider additionally includes piezoelectric force-measuring elements (PFEs).

In some aspects, the techniques described herein relate to a touch-sensing slider, wherein: the PFEs are piezoelectric micromechanical force-measuring elements (PMFEs); the PUTs are piezoelectric micromechanical ultrasonic transducers (PMUTs); and the PMUTs and the PMFEs are part of a monolithic IC.

In some aspects, the techniques described herein relate to a touch-sensing slider, wherein the monolithic IC includes the signal processor.

In some aspects, the techniques described herein relate to a touch-sensing slider, wherein a duration of the touch determination period is 100 ms or more.

In some aspects, the techniques described herein relate to a touch-sensing slider, wherein a duration of the touch determination period is 3000 ms or less.

In some aspects, the techniques described herein relate to a touch-sensing slider, wherein the duration of each of the sensing event time frames is 2 ms or less.

In some aspects, the techniques described herein relate to a touch-sensing slider, wherein the duration of each of the sensing event time frames is 100 μs or more.

In some aspects, the techniques described herein relate to a touch-sensing slider, wherein the duration of each of the sensing event time frames is 200 μs or more.

In some aspects, the techniques described herein relate to a touch-sensing slider, wherein: the touch determination period additionally includes a plurality of signal processing time frames, the signal processing time frames being interleaved with the sensing event time frames; and the signal processor receives additional signals from the touch sensor during the signal processing time frames; and the additional signals do not include the signals from the PUTs.

In some aspects, the techniques described herein relate to a touch-sensing slider, wherein a duration of each of the sensing time windows is 0.1 μs or more.

In some aspects, the techniques described herein relate to a touch-sensing slider, wherein a duration of each of the sensing time windows is 1000 μs or less.

In some aspects, the techniques described herein relate to a touch-sensing slider, wherein: the touch-sensing slider is configured to operate in one of multiple modes including a lower-power mode and a higher-power mode; the touch sensor is active in the higher-power mode and is inactive in the lower-power mode; the signal processor is configured to receive wake-up signals; and the signal processor is configured to determine whether to activate the touch sensor in accordance with the wake-up signals.

In some aspects, the techniques described herein relate to a touch-sensing slider, wherein: the touch-sensing slider includes a wake-up sensor coupled to the signal processor; the wake-up sensor includes a piezoelectric force-measuring element (PFE), a piezoresistive strain gauge, or an accelerometer; and the wake-up signals are received by the signal processor from the wake-up sensor.

In some aspects, the techniques described herein relate to a touch-sensing slider, wherein: the wake-up signals are received by the signal processor from an external source; and the wake-up signals are indicative of one or more of the following: (a) acceleration of an object, (b) vibration of an object, (c) force or pressure applied to an object, (d) a status of a user-interface device, and (e) a proximity of an object to the touch-sensing slider.

In some aspects, the techniques described herein relate to a method of sensing touch, the method including: (A1) providing a touch-sensing slider, including: a cover stack having an outer surface that can be touched by a finger, the cover stack having a longitudinal direction along which the finger can touch and slide on the outer surface; a touch sensor including piezoelectric capacitors mechanically coupled to the cover stack at its inner interface, the cover stack overlying the piezoelectric capacitors, the piezoelectric capacitors including one or more piezoelectric members, the piezoelectric capacitors being configured as piezoelectric ultrasonic transducers (PUTs), each of the PUTs being configured as a transmitting-type PUT and/or a receiving-type PUT, the piezoelectric capacitors being arranged in an array extending along at least one direction including the longitudinal direction, the transmitting-type PUTs being configured to transmit ultrasound waves towards the cover stack in a predetermined frequency range, the ultrasound waves propagating along a normal direction approximately normal to a plane of the one or more piezoelectric members, the receiving-type PUTs are configured to receive the ultrasound waves from the cover stack in the predetermined frequency range; and a signal processor coupled to the touch sensor and configured to receive signals from the PUTs while the touch sensor is active during a touch determination period, the touch determination period including a plurality of sensing event time frames, a duration of each of the sensing event time frames being 10 ms or less, each of the sensing event time frames includes a plurality of sensing time windows; (A2) for each of the sensing event time frames, transmitting, by one or more of the transmitting-type PUTs, the ultrasound waves during each of the sensing time windows; (A3) for each of the sensing event time frames, receiving, by one or more of the receiving-type PUTs, the ultrasound waves during each the sensing time windows; (A4) for each of the sensing event time frames, receiving, by the signal processor, the signals from the PUTs, the signals including signal portions in a time-division multiplexed arrangement, each of the signal portions being generated in accordance with the ultrasound waves received at the one or more of the receiving-type PUTs during a respective one of the sensing time windows; and (A5) determining, by the signal processor, from at least the signals, whether a touch event has occurred; (A6) determining, by the signal processor, from at least the signals, at least one other characteristic of the touch event, if the signal processor has determined that the touch event has occurred; and (A7) repeating (A2) through (A6) during the touch determination period.

In some aspects, the techniques described herein relate to a method, wherein the at least one other characteristic is selected from touch velocity, touch direction, touch pattern, touch location, transient strain, and transient applied force.

In some aspects, the techniques described herein relate to a method, wherein at least two of the piezoelectric capacitors share a common piezoelectric member among the one or more piezoelectric members.

In some aspects, the techniques described herein relate to a method, wherein at least two of the piezoelectric capacitors share a common electrode.

In some aspects, the techniques described herein relate to a method, wherein: the PUTs are piezoelectric micromechanical ultrasonic transducers (PMUTs); and the PMUTs are part of a monolithic IC.

In some aspects, the techniques described herein relate to a method, wherein the monolithic IC includes the signal processor.

In some aspects, the techniques described herein relate to a method, wherein the touch sensor is adhered to the cover stack by an adhesive including double-sided tape, pressure sensitive adhesive (PSA), epoxy adhesive, or acrylic adhesive.

In some aspects, the techniques described herein relate to a method, wherein: at least the touch sensor is encapsulated in a molded package; and at least a portion of the molded package is configured as the cover stack.

In some aspects, the techniques described herein relate to a method, wherein the piezoelectric member includes aluminum nitride, scandium-doped aluminum nitride, polyvinylidene fluoride (PVDF), lead zirconate titanate (PZT), KxNa1-xNbO3 (KNN), quartz, zinc oxide, lithium niobate, or Bi0.5Na0.5TiO3 (BNT).

In some aspects, the techniques described herein relate to a method, wherein at least one of the piezoelectric capacitors is also configured as a piezoelectric force-measuring element (PFE).

In some aspects, the techniques described herein relate to a method, wherein: the touch determination period additionally includes a plurality of signal processing time frames, the signal processing time frames being interleaved with the sensing event time frames; and the signal processor receives additional signals from the touch sensor during the signal processing time frames; and the additional signals include signals from the PFE.

In some aspects, the techniques described herein relate to a method, wherein the ultrasound waves transmitted by the transmitting-type PUTs have a beamwidth in a range of 100 μm to 10 mm at the outer surface of the cover stack.

In some aspects, the techniques described herein relate to a method, wherein the touch-sensing slider additionally includes piezoelectric force-measuring elements (PFEs).

In some aspects, the techniques described herein relate to a method, wherein: the PFEs are piezoelectric micromechanical force-measuring elements (PMFEs); the PUTs are piezoelectric micromechanical ultrasonic transducers (PMUTs); and the PMUTs and the PMFEs are part of a monolithic IC.

In some aspects, the techniques described herein relate to a method, wherein the monolithic IC includes the signal processor.

In some aspects, the techniques described herein relate to a method, wherein a duration of the touch determination period is 100 ms or more.

In some aspects, the techniques described herein relate to a method, wherein a duration of the touch determination period is 3000 ms or less.

In some aspects, the techniques described herein relate to a method, wherein the duration of each of the sensing event time frames is 2 ms or less.

In some aspects, the techniques described herein relate to a method, wherein the duration of each of the sensing event time frames is 100 μs or more.

In some aspects, the techniques described herein relate to a method, wherein the duration of each of the sensing event time frames is 200 μs or more.

In some aspects, the techniques described herein relate to a method, wherein: the touch determination period additionally includes a plurality of signal processing time frames, the signal processing time frames being interleaved with the sensing event time frames; the signal processor receives additional signals from the touch sensor during the signal processing time frames; and the additional signals do not include the signals from the PUTs.

In some aspects, the techniques described herein relate to a method, wherein a duration of each of the sensing time windows is 0.1 μs or more.

In some aspects, the techniques described herein relate to a method, wherein a duration of each of the sensing time windows is 1000 μs or less.

In some aspects, the techniques described herein relate to a method, wherein: the touch-sensing slider is configured to operate in one of multiple modes including a lower-power mode and a higher-power mode; the touch sensor is active in the higher-power mode and is inactive in the lower-power mode; and the method additionally includes: (B1) receiving, by the signal processor, wake-up signals; (B2) determining, by the signal processor, whether to activate the touch sensor in accordance with the wake-up signals; and (B3) carrying out (A2) through (A7) if the signal processor has determined to activate the touch sensor.

In some aspects, the techniques described herein relate to a method, wherein: the touch-sensing slider includes a wake-up sensor coupled to the signal processor; the wake-up sensor includes a piezoelectric force-measuring element (PFE), a piezoresistive strain gauge, or an accelerometer; and the wake-up signals are received by the signal processor from the wake-up sensor.

In some aspects, the techniques described herein relate to a method, wherein: the wake-up signals are received by the signal processor from an external source; and the wake-up signals are indicative of one or more of the following: (a) acceleration of an object, (b) vibration of an object, (c) force or pressure applied to an object, (d) a status of a user-interface device, and (e) a proximity of an object to the touch-sensing slider.

From the foregoing, it will be appreciated that specific embodiments of the invention have been described herein for purposes of illustration, but that various modifications may be made without deviating from the scope of the invention. Accordingly, the invention is not limited except as by the appended claims.

I/We claim:

1. A touch-sensing slider, comprising:
a cover stack having an outer surface that can be touched by a finger, the cover stack having a longitudinal direction along which the finger can touch and slide on the outer surface;
a touch sensor comprising piezoelectric capacitors mechanically coupled to the cover stack at its inner interface, the cover stack overlying the piezoelectric capacitors, the piezoelectric capacitors comprising one or more piezoelectric members, the piezoelectric capacitors being configured as piezoelectric ultrasonic transducers (PUTs); and
a signal processor coupled to the touch sensor and configured to receive signals from the PUTs while the touch sensor is active during a touch determination period, wherein:
each of the PUTs is configured as a transmitting-type PUT and/or a receiving-type PUT;
the piezoelectric capacitors are arranged in an array extending along at least one direction including the longitudinal direction;
the transmitting-type PUTs are configured to transmit ultrasound waves towards the cover stack in a predetermined frequency range, the ultrasound waves propagating along a normal direction approximately normal to a plane of the one or more piezoelectric members;
the receiving-type PUTs are configured to receive the ultrasound waves from the cover stack in the predetermined frequency range;
the touch determination period comprises a plurality of sensing event time frames;
a duration of each of the sensing event time frames is 10 ms or less;
each of the sensing event time frames comprises a plurality of sensing time windows;
for each of the sensing event time frames, the signals comprise signal portions in a time-division multiplexed arrangement, each of the signal portions being generated in accordance with the ultrasound waves received at one or more of the receiving-type PUTs during a respective one of the sensing time windows, one or more of the transmitting-type PUTs transmitting the ultrasound waves during the respective one of the sensing time windows;
the signal processor is configured to determine, from at least the signals, whether a touch event has occurred; and
the signal processor is configured to determine, from at least the signals, at least one other characteristic of the touch event, if the signal processor has determined that the touch event has occurred.

2. The touch-sensing slider of claim 1, wherein the at least one other characteristic is selected from touch velocity, touch direction, touch pattern, touch location, transient strain, and transient applied force.

3. The touch-sensing slider of claim 1, wherein at least two of the piezoelectric capacitors share a common piezoelectric member among the one or more piezoelectric members.

4. The touch-sensing slider of claim 1, wherein at least two of the piezoelectric capacitors share a common electrode.

5. The touch-sensing slider of claim 1, wherein:
the PUTs are piezoelectric micromechanical ultrasonic transducers (PMUTs); and
the PMUTs are part of a monolithic IC.

6. The touch-sensing slider of claim 5, wherein the monolithic IC comprises the signal processor.

7. The touch-sensing slider of claim 1, wherein the touch sensor is adhered to the cover stack at the inner interface by an adhesive comprising double-sided tape, pressure sensitive adhesive (PSA), epoxy adhesive, or acrylic adhesive.

8. The touch-sensing slider of claim 1, wherein:
at least the touch sensor is encapsulated in a molded package; and
at least a portion of the molded package is configured as the cover stack.

9. The touch-sensing slider of claim 1, wherein the piezoelectric member comprises aluminum nitride, scandium-doped aluminum nitride, polyvinylidene fluoride (PVDF), lead zirconate titanate (PZT), KₓNa₁₋ₓNbO₃ (KNN), quartz, zinc oxide, lithium niobate, or Bi_{0.5}Na_{0.5}TiO₃ (BNT).

10. The touch-sensing slider of claim 1, wherein at least one of the piezoelectric capacitors is also configured as a piezoelectric force-measuring element (PFE).

11. The touch-sensing slider of claim 10, wherein:
the touch determination period additionally comprises a plurality of signal processing time frames, the signal processing time frames being interleaved with the sensing event time frames; and
the signal processor receives additional signals from the touch sensor during the signal processing time frames; and
the additional signals comprise signals from the PFE.

12. The touch-sensing slider of claim 1, wherein the ultrasound waves transmitted by the transmitting-type PUTs have a beamwidth in a range of 100 μm to 10 mm at the outer surface of the cover stack.

13. The touch-sensing slider of claim 1, wherein the touch-sensing slider additionally comprises piezoelectric force-measuring elements (PFEs).

14. The touch-sensing slider of claim 13, wherein:
the PFEs are piezoelectric micromechanical force-measuring elements (PMFEs);
the PUTs are piezoelectric micromechanical ultrasonic transducers (PMUTs); and
the PMUTs and the PMFEs are part of a monolithic IC.

15. The touch-sensing slider of claim 14, wherein the monolithic IC comprises the signal processor.

16. The touch-sensing slider of claim 1, wherein a duration of the touch determination period is 100 ms or more.

17. The touch-sensing slider of claim 1, wherein a duration of the touch determination period is 3000 ms or less.

18. The touch-sensing slider of claim 1, wherein the duration of each of the sensing event time frames is 2 ms or less.

19. The touch-sensing slider of claim 1, wherein the duration of each of the sensing event time frames is 100 μs or more.

20. The touch-sensing slider of claim 19, wherein the duration of each of the sensing event time frames is 200 μs or more.

21. The touch-sensing slider of claim 1, wherein:
the touch determination period additionally comprises a plurality of signal processing time frames, the signal processing time frames being interleaved with the sensing event time frames; and
the signal processor receives additional signals from the touch sensor during the signal processing time frames; and
the additional signals do not comprise the signals from the PUTs.

22. The touch-sensing slider of claim 1, wherein a duration of each of the sensing time windows is 0.1 μs or more.

23. The touch-sensing slider of claim 1, wherein a duration of each of the sensing time windows is 1000 μs or less.

24. The touch-sensing slider of claim 1, wherein:
the touch-sensing slider is configured to operate in one of multiple modes including a lower-power mode and a higher-power mode;
the touch sensor is active in the higher-power mode and is inactive in the lower-power mode;
the signal processor is configured to receive wake-up signals; and
the signal processor is configured to determine whether to activate the touch sensor in accordance with the wake-up signals.

25. The touch-sensing slider of claim 24, wherein:
the touch-sensing slider comprises a wake-up sensor coupled to the signal processor;
the wake-up sensor comprises a piezoelectric force-measuring element (PFE), a piezoresistive strain gauge, or an accelerometer; and
the wake-up signals are received by the signal processor from the wake-up sensor.

26. The touch-sensing slider of claim 24, wherein:
the wake-up signals are received by the signal processor from an external source; and
the wake-up signals are indicative of one or more of the following: (a) acceleration of an object, (b) vibration of an object, (c) force or pressure applied to an object, (d) a status of a user-interface device, and (e) a proximity of an object to the touch-sensing slider.
